(19) United States
(12) Patent Application Publication
(10) Pub. No.: US 2002/0079799 A1
(43) Pub. Date: Jun. 27, 2002

(54) Circular multiple-electrode energy-saving spark plug and the method of manufacturing

(76) Inventor: Hong-Qi Yang, Beijing (CN)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 09/746,315

(22) Filed: Dec. 22, 2000

(51) Int. Cl. H01T 13/20

(52) U.S. Cl. 313/141; 313/140

(57) ABSTRACT

A type of ring form multiple-electrode spark plug consisting of an outer case, a ceramic insulation body, a central electrode situated inside the ceramic insulation body, a lateral electrode, one wire connector screw connected to the central electrode, and a wire connector screw cap. The plug possesses the following special features: the lateral electrode mentioned consists of several metal circular rings situated on the insulation body of the ignition end part of the spark plug; the central electrode is connected with a polygonal metal plate, when electricity is discharged under high pressure, there will be appearance of multiple-point sparks between the circular rings and the metal plate as well as between the circular rings themselves, thus producing multiple-point sparks

### FIELD OF THE INVENTION

The present invention is a type of energy-saving spark plug used in an internal combustion engine, particularly used as an ignition device for internal combustion engines.

### BACKGROUND OF THE INVENTION

A prior art spark plug is made of ceramic material as illustrated in FIG. 1. The spark plug consists of an outer case A, a ceramic insulator B, a central electrode C, and a lateral electrode D. When the spark plug is ignited, by way of the high-pressure discharge, electric sparks are produced between the central electrode C and the lateral electrode D, thus igniting fuel in the combustion chamber. The spark plug uses a single point of ignition; thus, the work of ignition is not reliable due to carbon build up, which brings about ignition failure.

### SUMMARY OF THE INVENTION

The purpose of the present invention is to provide a modem type of circular multiple-electrode energy-saving spark plug, which overcomes the defects of spark plugs used at the present. The present invention provides multiple-site ignition, increased ignition reliability, increased working effects of an engine, and reduced fuel consumption, which aids in the reduction of environmental pollution.

The present invention consists of an outer case, a ceramic insulator, a central electrode situated inside the ceramic insulation body, a lateral electrode, a wire connector screw, and a wire connector screw cap. Particular to the present invention are lateral electrodes, including several metal circular rings, situated on the insulator at the terminal end of the ignition of the spark plug, while the central electrode is connected with a polygonal metal plate. During the time of high-pressure discharge, multiple-point electrical sparks will be produced between the rings, the metal plates and among the rings themselves.

The present invention can produce multiple-point sparks in the process of ignition; therefore, it provides a large ignition capacity, with reliable ignition, causing vehicles to start easier in cold weather seasons. An additional benefit to the present invention is that fuel is fully combusted, saving fuel and reducing the possibility of polluting the environment.

The present invention is described in the following with attached figures according to the examples practiced.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is the cut-open view of an ordinary spark plug, used at present;

FIG. 2 is the cut-open view of a multiple-electrode ring form spark plug of this invention;

FIG. 3 is the lateral view of the head part of the ring form multiple-electrode spark plug described in FIG. 2 showing purposely the working state of multiple-site ignition sparks of the spark plug;

FIG. 4 is the top view of the head part of the ring form multiple-electrode spark plug in this invention; and

FIG. 5 shows the figure of installation of the lateral electrode and central electrode of the ring form multiple-electrode spark plug in this invention.

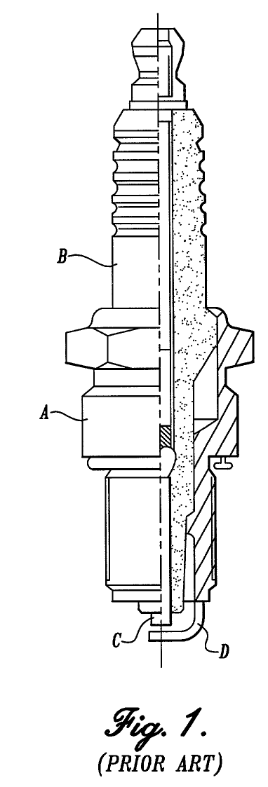

### DETAILED DESCRIPTION OF THE PREFERRED EMBODIMENT

As summarized above, the present invention describes a type of energy saving multiple electrode spark plug used in internal combustion engines. With reference to the drawings, in which like numerals indicate like elements throughout the several figures, embodiments of the invention are discussed in detail below.

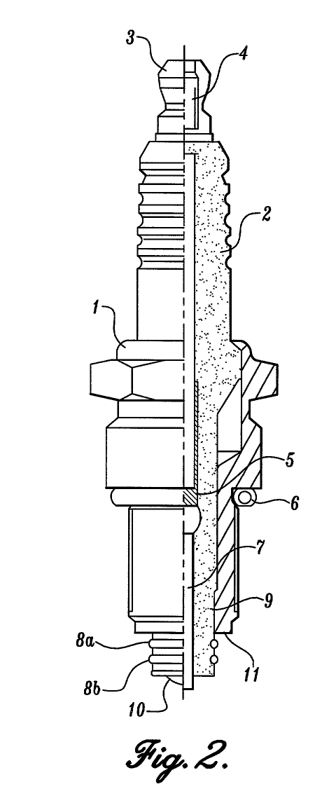

FIG. 2 is an overview of the physical components representative of one embodiment of the present invention. In FIG. 2, the multiple-electrode spark plug consists of an outer case 1, having a first bolt head and a second threaded end, with a hollow cavity and a ceramic insulation body 2, which is placed within the hollow cavity of the outer case 1. On the outer surface of the outer case 1 at the joint end of the top of the threaded end is a compression ring 6, which is used at the time a spark plug is installed in a internal combustion engine to seal the spark plug to the engine block, which prevents block-back.

At one end of the ceramic insulation body 2 is a wire connector screw cap 3, a wire connector screw 4, and a central electrode 7, which runs along the axis of the central insulation body 2 from the first end to the second end. At the first end of the central electrode 7, the central electrode is bonded to the wire connector screw 4, thus creating a path for current flow. At the second end of the central electrode 7, a lateral electrode metal plate is bonded to the central electrode forming an end point, with the bond point such that current may flow from the central electrode 7 to the lateral electrode metal plate 10. The central electrode 7 is created by filling the ceramic insulation body 2 with a conductive glass gel 5, which when bonded with the wire connector screw 4 and the electrode metal plate 10 forms a conductive pathway for current.

A spark-generating assembly is formed around the ceramic insulation body 2, whereby a first lateral electrode metal ring 8a is positioned adjacent to the end surface of the outer case 11 and the second lateral electrode metal ring 8b. A second lateral electrode metal ring 8b is positioned such that it is adjacent to the first lateral electrode metal ring 8a and the electrode metal plate 10. The distance measured along the axis of the ceramic insulation body 2 between each of the electrode metal rings 8a and 8b, the end surface of the outer case 11 and the electrode metal plate 10 are equidistant. The approximate distance from the electrode metal plate 10 to the end surface of the outer case 11 is 5 millimeters.

In another embodiment of the present invention, the electrode metal rings 8a and 8b need not encompass only two electrode metal rings. There can be a plurality of rings or only one. The purpose of more than one ring is to magnify the occurrence of sparks generated over the entire structure of the spark generating assembly. Maintaining optimal distance for spark propagation from the end of the outer case to the electrode metal plate 10 decreases the resistance needed to overcome bridging each gap.

In FIG. 3, the spark-generating assembly is illustrated. As described in the preceding discussion of FIG. 2, a spark-generating assembly is formed around the ceramic insulation body 2, whereby a first lateral electrode metal ring 8a is positioned adjacent to the end surface of the outer case and the second lateral metal electrode ring 8b. A second lateral electrode metal ring 8b is positioned such that it is adjacent to the first lateral electrode metal ring 8a and the electrode metal plate 10. It should be noted that the lateral electrode metal rings 8a and 8b are bonded to the ceramic insulation body, whereby a non-conductive surface is formed between the lateral metal rings 8a and 8b and the ceramic insulation body. The purpose behind this bonding is to insure propagation of sparks to and from an electrode metal ring to a second conductor. The effect is very similar to that of lighting jumping from one potential to another. Many random sparks are formed because of this configuration and are random in occurrence location on each electrode metal ring.

The metal electrode metal plate 10 illustrated in FIG. 3 further illustrates the lateral exploitation of conductive surfaces used in the present invention. As the final point by which energy is conducted, the electrode metal ring forms the points in which sparks are attracted. The present invention uses a hexagonal metal plate; however, it will be appreciated by those in the art that a plurality of surfaces yield more points to which a spark may be attracted. Due to carbon build-up, each point hat a spark touches will build up carbon. Over time carbon build-up has a negative effect of spark attraction. By having multiple points in the present invention this form of carbon buildup is greatly reduced, while maintaining a higher propagation of sparks versus prior art solutions.

The advantages of the spark-generating assembly illustrated in FIG. 3 is that the ignition ability and reliability is raised, especially in cold seasons, or under the circumstances where the gasifying process is very poor. The attendant advantages are that vehicles are more easily started and carbon accumulation is reduced at the time of combustion, thus the combustion of fuel is improved, obtaining a savings in the fuel consumption as well as reducing environmental pollution.

The ignition distance in total for the spark-generating assembly of the present invention is between 3 to 5 millimeters. Furthermore, the present invention is a multiple-site ignition type, so the total ignition capacity is tremendously increased as compared with the space of 0.6-1 millimeters of those commonly used by ordinary spark plugs. Through bench tests in engines, the present invention can form 10-20 more electrical sparks during operation compared to bench tests in engines using prior art spark plugs. There appears to be a 5% reduction of oil consumption for each 100 km, release of CO₂ is decreased by 14%, and release of HC reduced by 73.3%. Consequently, the goals of reliability in ignition, fuel saving, and reduction of environmental pollution are achieved.

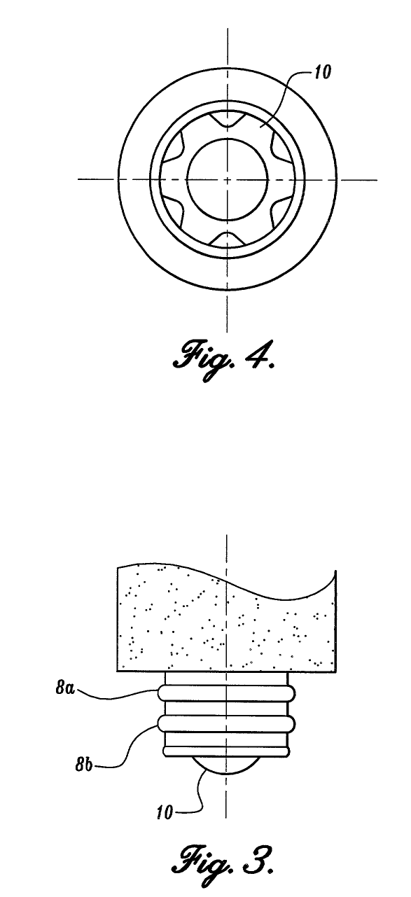

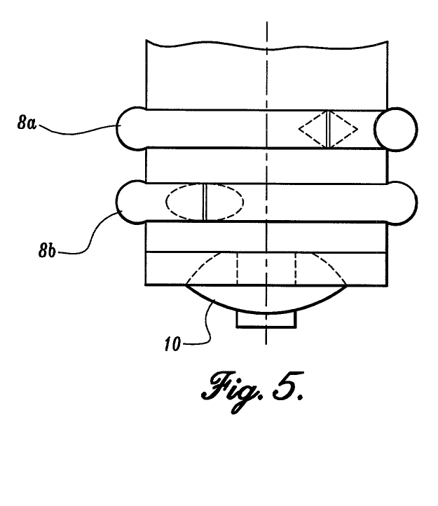

FIG. 4 illustrates a top down view of the hexagonal electrode metal plate used in the present invention. As illustrated, spark attractive surfaces are evident at six points on the hexagon, yet the present invention is not limited to simply those surfaces. An attendant advantage of the present invention is that the quantity of sparks that are generated far exceeds those offered by the prior art, which typically has only one surface in which sparks may propagate.

The method of manufacturing the present invention is illustrated in FIG. 5. FIG. 5 reveals the figure of installation for the lateral and electrode metal plate.

In this installation, the form of joining method of the electrode metal plate 10 to the central electrode is protected by argon, the point of juncture is completed by self-melting, with the self-melting time being φ2.5▪φ3.5/2.5 seconds, thus making the gap between the end surface of the hexagonal metal plate and that of the collision part no more than 0.2 millimeters.

The juncture of the cut notch part of the electrode metal rings 8a and 8b on the lateral electrode is protected by argon, the point of juncture is done by self-melting with the self-melting time being φ▪3.1.5-1.8 mm/1.5 seconds, the matched space between the inner diameter of the electrode metal ring and the slot of the collision ring is not longer than 0.02 millimeters.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A spark plug, comprising:
(a) an outer case having a ground electrode surface;
(b) an insulation body disposed within the outer case, the insulation body having a length and first and second ends;
(c) a central electrode having first and second ends and extending through the length of the insulation body;
(d) a cap disposed at the first end of the central electrode; and
(e) a spark generating assembly coupled to the second end of the central electrode, wherein the spark generating assembly comprises:
(i) an electrode plate with a plurality of edges positioned laterally, disposed at the second end of the central electrode; and
(ii) a first spark conductive member coupled to the central electrode and spaced a predetermined distance from the electrode plate.

2. The spark plug of claim 1, wherein the electrode plate is a metal plate having a plurality of points, whereby the plurality of points propagate sparks from the spark generating assembly.

3. The spark plug of claim 2, wherein the electrode plate is formed as a hexagonal plate.

4. The spark plug of claim 3, wherein the metal plate has a predetermined thickness to maximize ignition efficiency.

5. The spark plug of claim 4, wherein the thickness of the metal plate is one millimeter.

6. The spark plug of claim 5, wherein the metal plate has a diagonal measurement of six millimeters.

7. The spark plug of claim 1, wherein the first spark conductive member includes at least one metal ring disposed around the central electrode.

8. The metal ring of claim 7, wherein said at least one metal ring has a diameter of one millimeter.

9. The spark plug of claim 3, wherein a protective coating is applied to the central electrode.

10. The spark plug of claim 9, wherein the protective coating is argon.

11. The spark plug of claim 3, wherein the hexagonal plate is fastened to the central electrode by a self-melting process.

12. The spark plug of claim 11, wherein the self-melting process has a melting time of φ2.5▪φ3.5/2.5 seconds.

13. The spark plug of claim 7, wherein a protective coating is applied to the juncture of a cut notch part of the metal ring.

14. The spark plug of claim 13, wherein the protective coating is argon.

15. The spark plug of claim 7, wherein the two metal rings are fastened to the central electrode by a self-melting process.

16. The spark plug of claim 15, wherein the self-melting process has a melting time of φ3▪1.5-1.8 mm/1.5 seconds.

17. The spark plug of claim 1, wherein the spark conductive member includes a plurality of metal rings disposed around the central electrode spaced such that the ground electrode, the plurality of metal rings, and electrode plate each is spaced equidistant along the central axis of the second end of the of the central electrode.

18. The spark plug of claim 1, further comprising a total space between the electrode plate and the ground electrode surface of the outer case is 3 to 5 millimeters.

19. A method of manufacturing a spark plug:
(a) formed by an outer case having a ground electrode surface composed of an insulation body having predetermined length and first and second ends, a central electrode disposed within the insulation body and a first and second end, a cap disposed at the first end of the central electrode and a spark generating assembly disposed at the second end of the central electrode, including comprising the step of forming a spark generating assembly, the spark generating assembly comprising an electrode plate disposed at the second end of the central electrode and a first spark conductive member coupled to the central electrode, spaced a predetermined distance from the electrode plate.

20. The method of claim 19, further comprising applying a protective coating to the central electrode wherein the protective coating is argon.

21. The method of claim 19, further comprising connecting the metal plate and the central electrode by a self-melting process.

22. The method of claim 21, wherein the self melting process time is φ2.5▪φ3.5/2.5 seconds.

23. The method of claim 19, further comprising applying a protective coating to the notched portion of the metal ring to the central electrode wherein the protective coating is argon.

24. The method of claim 19, further comprising connecting the notched portion of the ring to the central electrode by a self melting process.

25. The method of claim 24, wherein the self melting process time is φ3▪1.5-1.8 mm/1.5 seconds.

26. A spark plug, comprising:
(a) an outer case having a ground electrode surface;
(b) an insulation body disposed within the outer case, the insulation body having a length and first and second ends;
(c) a central electrode having first and second ends and extending through the length of the insulation body;
(d) a cap disposed at the first end of the central electrode; and
(e) a spark generating assembly coupled to the second end of the central electrode, wherein the spark generating assembly comprises:
(i) a metal plate disposed at the second end of the central electrode; and
(ii) a plurality of lateral electrode metal rings coupled to the central electrode and spaced a predetermined distance from the metal plate.

27. The spark plug of claim 28, wherein the metal plate is formed as a hexagonal plate, having a thickness of 1 millimeter and a diagonal measurement of 6 millimeters.

28. The metal ring of claim 28, wherein each lateral electrode metal ring has a diameter of 1 millimeter.

29. The spark plug of claim 28, wherein the hexagonal plate is fastened to the central electrode by a self-melting process, with a protective coating of argon applied to the central electrode, with a self-melting time of φ2.5▪φ3.5/2.5 seconds.

30. The spark plug of claim 28, wherein the two lateral electrode metal rings are fastened to the central electrode by a self-melting process, with a protective coating of argon applied to the juncture cut notch part of each circular lateral electrode metal ring, with a self-melting time of φ3▪1.5-1.8 mm/1.5 seconds.

31. The spark plug of claim 28, further comprising a total space between the metal plate and the ground electrode surface of the outer case is 3 to 5 millimeters.
